(19) United States
(12) Patent Application Publication
(10) Pub. No.: US 2026/0344711 A1
(43) Pub. Date: Nov. 5, 2026

(54) Enhanced Hydration Beverages with Improved Taste

(71) Applicant: The Coca-Cola Company, Atlanta, GA (US)

(72) Inventors: Indra Prakash, Alpharetta, GA (US); Zhu Gao, Sandy Springs, GA (US); Debora Noleta, Atlanta, GA (US)

(21) Appl. No.: 19/110,869

(22) PCT Filed: Sep. 22, 2023
(86) PCT No.: PCT/US2023/074865

§ 371 Date: Mar. 12, 2025

Related U.S. Application Data
(60) Provisional application No. 63/409,486, filed on Sep. 23, 2022.

(51) Int. Cl. A23L 2/60; A23L 2/02; A23L 2/54; A23L 2/56

(52) U.S. Cl. CPC A23L 2/60; A23L 2/02; A23L 2/54; A23L 2/56

(57) ABSTRACT

Disclosed herein are enhanced water beverages comprising sucralose and monk fruit extract (MFE), as well as methods of improving the taste or off-taste of enhanced water beverages utilizing a sweetener system comprising sucralose and MFE. Also disclosed are methods of preparing enhanced water beverages having improve taste or off-taste.

### CROSS-REFERENCE TO RELATED APPLICATIONS

This application claims priority to U.S. Provisional Application No. 63/409,486, filed Sep. 23, 2022, which is incorporated herein in its entirety.

### FIELD OF THE INVENTION

Disclosed herein are enhanced water beverages (e.g., fruit-flavored enhanced water beverages) sweetened with sucralose and monk fruit extracts (MFE).

### BACKGROUND OF THE INVENTION

In recent years there has been a significant increase in demand for alternatives to traditional non-carbonated bottled water beverages (tap, spring, or purified), including beverages that can provide health benefits to the consumer beyond simple rehydration. Specifically, vitamin, minerals, electrolyte, and/or herb fortified beverages are of significant interest. Such beverages are referred to as “enhanced water beverages”, “near water beverages,” “functional beverages”, and “sports beverages,” among others.

The enhanced water beverages can be full-calorie (sweetened with, e.g., sucrose), mid-calorie, or zero-calorie beverages. Consumers increasingly prefer “no sugar” versions of beverages generally, and varieties of enhanced water beverages with no sucrose are available (e.g., Vitaminwater® Zero Sugar). Low or no calorie enhanced water beverages contain high potency sweeteners, including natural high potency sweeteners, to provide sweetness in the absence of sucrose. Stevia-based and monk fruit-based (Luo Han Guo) natural high potency sweeteners are popular. However, these sweeteners are known to elicit off-tastes that are objectionable to consumers and taste different than sucrose, e.g., delayed sweetness onset, lingering sweet aftertaste, bitter taste, metallic taste, astringent taste, cooling taste, licorice-like taste, watery taste, and poor mouthfeel. Additionally, flavor components of enhanced water beverage can be muted when high potency sweeteners are used.

There remains a need for enhanced water beverages sweetened with natural high potency sweeteners that have improved taste and flavor profiles.

### SUMMARY OF THE INVENTION

Disclosed herein are enhanced water beverages (e.g., fruit-flavored enhanced water beverages) sweetened with sucralose and monk fruit extract (MEF). In certain embodiments, the enhanced water beverages have one or more improved sensory characteristics or attributes (e.g., reduced bitterness, improved mouthfeel, reduced sweetness linger, improved sweetness onset) compared to enhanced water beverages known in the art.

In a first aspect, a enhanced water beverage is provided comprising sucralose and a monk fruit extract (MFE), wherein the beverage does not contain erythritol.

In a second aspect, a method of improving one or more sensory characteristics or attributes of an enhanced water beverage is disclosed comprising (i) providing a monk fruit extract (MFE) and sucralose; (ii) adding the MFE and sucrose to a beverage matrix, wherein the beverage does not comprise erythritol.

In a third aspect, a method of making an enhanced beverage is disclosed comprising (i) providing a monk fruit extract (MFE) and sucralose; (ii) adding the MFE and sucrose to a beverage matrix, wherein the enhanced water beverage does not comprise erythritol.

In one embodiment, the enhanced water beverage does not contain rebaudioside A or rebaudioside B.

In one embodiment, the enhanced water beverage does not contain allulose.

In one embodiment, the enhanced water beverage comprises between about 85 and 100 ppm sucralose. In a particular embodiment, the enhanced water beverage comprises about 90 to about 95 ppm sucralose.

In one embodiment, the enhanced water beverage comprises between about 45 and about 55 ppm monk fruit extract. In a particular embodiment, the enhanced water beverage comprises between about 48 and about 52 ppm monk fruit extract.

In a particular embodiment, the enhanced water beverage comprises between about 90 to about 95 ppm sucralose and between about 45 and about 55 ppm monk fruit extract.

In one embodiment, the monk fruit extract comprises at least about 35% mogroside V.

In one embodiment, the monk fruit extract comprises between about 35% and about 55% mogroside V.

In one embodiment, the monk fruit extract comprises about 50% mogroside V.

In a particular embodiment, the enhanced water beverage comprises between about 90 to about 95 ppm sucralose and between about 45 and 50 ppm monk fruit extract, wherein the monk fruit extract comprises about 50% mogroside V.

In one embodiment, the enhanced water beverage has a sucrose equivalence (SE) between about 4 and about 8% SE. In a particular embodiment, the, the enhanced water beverage has a sucrose between about 7 and about 8% SE.

In a particular embodiment, the enhanced water beverage comprises between about 90 to about 95 ppm sucralose and between about 45 and 50 ppm monk fruit extract, wherein the monk fruit extract comprises about 50% mogroside V and the enhanced water beverage has a sucrose equivalence of between about 7 and 8% SE.

In one embodiment, the enhanced water beverage further comprises phloretin.

In a particular embodiment, the enhanced beverage comprises about 500 ppm phloretin.

In one embodiment, the enhanced water beverage is non-carbonated. In another embodiment, the enhanced water beverage is carbonated.

### DETAILED DESCRIPTION

### I. Definitions

The term “additive” or “addition” as used herein refers to the expected effect when compounds are combined, i.e., the sum of the effects of the individual compounds. Any deviation from additivity is considered synergy or antagonism.

The term “antagonism” as used herein refers to a surprising and unexpected effect when the combined effect of compounds is less than the additive effect expected. It is the opposite of synergy. Synonyms include, e.g., subadditivity, depotentiation, negative interaction, negative synergy, infra-additive. In one embodiment of the compositions disclosed herein, the use of sucralose and MFE in combination produces less bitterness than the combination of MFE and sucralose, each known to impart some bitterness, would be expected to provide.

The term “beverage” as used herein refers to liquids suitable for human consumption. In on embodiment, the beverages disclosed herein are in a liquid form ready to be consumed without further addition of liquid, i.e., ready to drink beverages.

The term “bitter” or “bitter taste perception” are used interchangeably herein to refer to one of the five basic taste qualities that include sweet, sour, salty, bitter, and umami (savory). It is peculiarly sharp, acrid, astringent, rancid and/or metallic taste and generally disagreeable or unpleasant. Bitterness is generally understood to perceived by activation of at least one or more of 25 different bitter taste receptors (TAS2Rs) located in the taste buds of the tongue. Bitterness can be determined by means of taste tests (e.g., using trained sensory evaluation), a bitter receptor assay (e.g., a cell-based bitter receptor assay) or other means known in the art. A single compound can have both sweet and bitter taste perception, e.g., high potency sweeteners.

The term “enhanced water beverage” as used herein refers to a beverage marketed as water with one or more added ingredients, such as vitamins and minerals.

The term “extract” as used herein refers to refers to a composition comprising one or more compounds separated from monk fruit by an extraction process. In one embodiment, the monk fruit is ripe at the time of extraction. In one embodiment, the monk fruit is fresh (not dried) at the time of extraction. In another embodiment, the monk fruit is vacuum-dried at the time of extraction.

The term “high-intensity sweetener” as used herein refers to sweeteners that are many times sweeter than sucrose. Representative, non-limiting examples include sucralose, aspartame, advantame, acesulfame-potassium, neotame and saccharine. Some individuals report unpleasant sensations from these sweeteners, such as bitter and metallic side tastes.

The term “improved” as used herein with reference to a property (e.g., taste, mouth feel, sweetness onset) refers to a detectable positive change in the property when compared to a standard. The degree of improvement may vary.

The term “mogroside” as used herein refers to a group of cucurbitane triterpenoid glycosides found in certain plants such as monk fruit. They include mogroside II A1, mogroside II B, 7-oxomogroside II E, 11-oxomogroside A1, mogroside III A2, 11-deoxymogroside III, 11-oxomogroside IV A, mogroside V, 7-oxomogroside V 11-oxo-mogroside V and mogroside VI.

The term “monk fruit” as used herein refers to the fruit of the herbaceous perennial vine, Siraitia grosvenorii, that is native to the tropical regions of South Eastern Asia, where is it sometimes referred to as Luo Han Guo. Monk fruit contains essential oil, saccharides, proteins, vitamins and flavors. It is also rich in mogrosides. Monk fruit extract is known for use as a sweetener. However, monk fruit extract is known to be associated with a sweetness linger and an off-taste. Monk fruit extracts available from commercial sources may be used in the present invention. Alternatively, the monk fruit extract made be prepared from monk fruit prior to use according to any method know in the art. Monk fruit extracts as used herein may be raw or further purified or concentrated to increase the content of mogrosides therein, including mogroside V.

The term “mouthfeel” as used herein refers to the physical sensations experienced or felt in the mouth that are created by a beverage or a component thereof. Mouthfeel may refer to textures that come into contact with the tongue, roof of the mouth, teeth, gums, or throat. Mouthfeel is considered to be distinct from taste/flavor. Examples of mouthfeel that are considered to be unpleasant include a drying sensation.

The term “off-taste” as used herein refers to an amount or degree of taste that is not characteristically or usually found in composition, such as a beverage product, and is generally used in an undesirable sense. In one embodiment, an off-taste may be bitter, astringent, cooling, metallic, or a combination thereof. In embodiments herein, the beverage compositions (e.g., enhanced water beverage compositions) disclosed herein exhibit reduced or no off-taste compared to beverage compositions known in the art.

The term “phloretin” as used refers to a simple dihydrochalcone found in certain fruit (e.g., apples, strawberries). More specifically, it is the aglucone portion of phlorizin and is a polyphenolic compound. It is split from phlorizin by acid hydrolysis. Alternatively, phloretin can be completely synthesized directly by known processes. Phloretin is known to have a sweet taste but also to exhibit an off-taste.

The term “parts per million” or “ppm” as used herein parts per million on a w/w or wt/wt basis.

The term “reduced” as used herein refers to a detectable negative change in the property when compared to a standard.

The term “solvent” as used herein refers to a liquid that can dissolve or substantially disperse another substance. Water is an example of a solvent. A solvent may be a combination of two or more distinct solvents.

The term “sucralose” as used herein refers to a non-nutritive sweetener that is derived from sucrose by replacing the hydroxyl groups in the 4, 1′, and 6′ positions with chlorine. It provides a much greater intensity than sucrose. However, the use of sucrose has been associated with sweetness linger and an off-taste.

The term “sucrose equivalence” or “SE” as used herein refers to the amount of non-sucrose sweetener required to provide the sweetness of a given percentage of sucrose in the composition, e.g., beverage.

The term “sweetener” as used herein refers to a product for oral consumption that produces a sweet taste when consumed alone. Representative, non-limiting sweeteners include high-intensity sweeteners, bulk sweeteners, sweetening agents, and low sweetness products produced by synthesis, fermentation or enzymatic conversion methods. In certain embodiments herein, the beverage (e.g., the enhanced water beverage) includes one or more sweeteners.

The term “sweetener system” as used herein refers to a system comprising one or more compounds that are used together to sweetener a sweeten-able composition (e.g., a beverage) when provided separately to the composition. In certain embodiments herein, a high-intensity sweetener (e.g., sucralose) and monk fruit extract constitute a sweetener system for use in sweetening beverages, such an enhanced water beverage. In a particular embodiment, the high-intensity sweetener (e.g., sucralose) and the monk fruit extract are the only sweeteners present in the beverage. Optionally, the beverage may contain other flavorants or tastants.

The term “synergy” or “synergistic effect” as used herein refers to the surprising and unexpected effect when the combination effect of two or more compounds is greater than the additive effect expected.

The term “temporal profile” as used herein with reference to a composition or sweetener is a measure of the perceived sweetness intensity of said composition or sweetener over time. A desirable or advantageous temporal profile is one wherein sweetness is observed quickly and has a short linger similar to that of sucrose. A less desirable or disadvantageous temporal profile is one in whether the perception of sweetness is delayed or has a linger beyond that of sucrose.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### II. Beverages

Disclosed herein are beverages, such as enhanced water beverages, sweetened with high potency sweeteners (e.g., sucralose) and monk fruit material derived, extracted or otherwise obtained from monk fruit. In one embodiment, the monk fruit material is a monk fruit extract (MFE).

The enhanced water beverages comprise a beverage matrix, i.e., the basic ingredient in which the ingredients are dissolved. The beverage matrix may be any suitable drinkable liquid.

In one embodiment, a beverage comprises water of beverage quality as the matrix, such as, for example deionized water, distilled water, reverse osmosis water, carbon-treated water, purified water, demineralized water and combinations thereof, can be used. Additional suitable beverage matrices ingredients include, but are not limited to phosphoric acid, phosphate buffer, citric acid, citrate buffer and carbon-treated water.

In certain embodiments, the water is present in the beverage in at least about 90% w/v, at least about 91% w/v, at least about 92% w/v, at least about 93% w/v, at least about 94% w/v, at least about 95% w/v, at least about 96% w/v, at least about 97% w/v, at least about 98% w/v, at least about 99% w/v, at least about 99.1% w/v, at least about 99.2% w/v, at least about 99.3% w/v, at least about 99.4% w/v, at least about 99.5% w/v, at least about 99.6% w/v, at least about 99.7% w/v, at least about 99.8% w/v, at least about 99.9% w/v.

A non-limiting example of the pH range of the enhanced water beverage may be from about 1.8 to about 10. A further example includes a pH range from about 2 to about 5. In a particular embodiment, the pH of beverage can be from about 2.5 to about 4.2.

The enhanced water beverages can be caffeinated (i.e., it contains caffeine) or non-caffeinated. Caffeine, also known as 1,3,7-trimethyl xanthine, is a white, odorless, bitter-tasting substance. Where caffeine is present, the total amount of caffeine may be, for example, between about 1 and about 3 vol.

The enhanced water beverages can be flavored. In one embodiment, the enhanced water beverage is fruit-flavored. Examples of fruit-flavorings include lime, grape, mango, watermelon, coconut, lemon, orange, tangerine, raspberry, apple, pear, peach, blackberry, and strawberry fruit flavors. The total amount of the flavoring agent may be from about 0.0001 to about 1.0% (w/w).

The temperature of the enhanced water beverage may, for example, range from about 4 °C to about 100 °C, such as, for example, from about 4 °C to about 25 °C.

In one embodiment, the enhanced water beverage does not contain erythritol.

In one embodiment, the enhanced water beverage does not contain a rebaudioside, such as rebaudioside A or rebaudioside B.

In one embodiment, the enhanced water beverage does not contain a rare sugar, such as allulose.

The monk fruit extract may be any suitable monk fruit extract. It may be obtained from the leaves and/or other plant structures such as fruits, seeds, stems or fleshy plant parts of the monk fruit. In a particular embodiment, the monk fruit extract is washed, the seeds and fruit skin are optionally removed, and the fruit is then crushed, followed by filtration and extraction of the crushed fruit using an appropriate solvent system (e.g., water extraction). Representative, non-limiting examples of methods for preparing monk fruit extracts are found in US Patent Publication Nos. 20110021456 and 20210274822A1.

In one embodiment, the monk fruit extract is prepared from fresh (not dried) monk fruit after harvesting. In another embodiment, the monk fruit extract is prepared from monk fruit that has been harvested and then dried. Any suitable method of drying can be used. Representative, non-limiting examples of drying methods include freeze-drying, freeze-vacuum drying, microwave drying, microwave-vacuum drying, microwave-vacuum infrared drying, and freezing followed by microwave-vacuum drying.

In certain embodiments, the monk fruit extract is further processed, for example by decolorization, purification and/or concentration. In a particular embodiment, the monk fruit extract is enriched for one or more mogrosides. Impurities may be removed, for example, using adsorption (e.g., using activated carbon) and elution steps. In a particular embodiment, the monk fruit extract is not treated with erythritol.

The composition of the monk fruit extract may vary, for example, due to growing conditions and/or the preparation process. The composition of the extract can be analyzed by any suitable method, such as high-performance thin-layer chromatography (HPTLC).

In one embodiment, the monk fruit extract comprises mogroside I, mogroside II, mogroside III, mogroside IV, neomogroside, 11-oxo-mogroside V, mogroside VI, mogroside V, and siamenoside I or a combination thereof. In certain embodiments, the monk fruit extract contains one or more proteins or protein fragments.

In one embodiment, the total mogroside content of the MFE is about 85 wt. % or more, about 88 wt. % or more, about 90 wt. % or more, about 92 wt. % or more, about 94 wt. % or more, about 96 wt. % or more or about 95 wt. % or more.

In one embodiment, the monk fruit extract contains mogroside V:

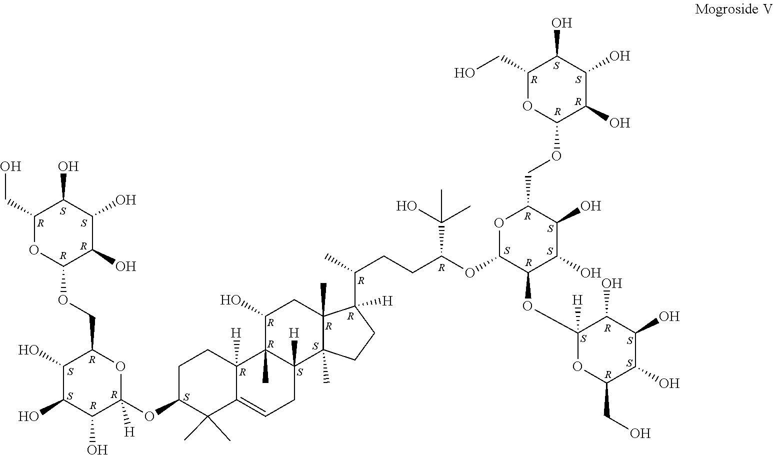

Mogroside V is highly sweet and low calorie. The amount of mogroside V in the MFE extract may vary. In one embodiment, the mogroside V content of the MFE is at least about 35 wt. % or more particularly, at least about 38 wt. %, at least about 40 wt. %, at least about 42 wt. %, at least about 44 wt. %, at least about 46 wt. %, at least about 48 wt. %, at least about 50 wt. %, at least about 52 wt. %, at least about 54 wt. %, at least about 56 wt. %, at least about 58 wt. %, at least about 60 wt. %, at least about 62 wt. %, at least about 64 wt. %, at least about 66 wt. %, at least about 68 wt. %, at least about 70 wt. %, at least about 72 wt. %, at least about 74 wt. %, at least about 76 wt. %, at least about 78 wt. % or at least about 80 wt. % mogroside V.

In one embodiment, the monk fruit extract comprises between about 35 and about 55 wt. % mogroside V or more particularly, about 35%, about 38%, about 40%, about 42%, about 44%, about 46%, about 48%, about 50%, about 52% or about 55% mogroside V.

In one embodiment, the monk fruit extract comprises less than about 99%, 98%, 97%, 96% or 95% mogroside V.

The amount of the monk fruit extract in the beverage may vary. In one embodiment, the monk fruit extract is present in the beverage in about 10 ppm, about 11 ppm, about 12 ppm, about 13 ppm, about 14 ppm, about 15 ppm, about 16 ppm, about 17 ppm, about 18 ppm, about 19 ppm, about 20 ppm, about 21 ppm, about 22 ppm, about 23 ppm, about 24 ppm, about 25 ppm, about 26 ppm, about 27 ppm, about 28 ppm, about 29 ppm, about 30 ppm, about 31 ppm, about 32 ppm, about 33 ppm, about 34 ppm, about 35 ppm, about 36 ppm, about 37 ppm, about 38 ppm, about 39 ppm, about 40 ppm, about 41 ppm, about 42 ppm, about 43 ppm, about 44 ppm, about 45 ppm, about 46 ppm, about 47 ppm, about 48 ppm, about 49 ppm, about 50 ppm, about 51 ppm, about 52 ppm, about 53 ppm, about 54 ppm, about 55 ppm, about 56 ppm, about 57 ppm, about 58 ppm, about 59 ppm, about 60 ppm, about 61 ppm, about 62 ppm, about 63 ppm, about 64 ppm, about 65 ppm, about 66 ppm, about 67 ppm, about 68 ppm, about 69 ppm, about 70 ppm, about 71 ppm, about 72 ppm, about 73 ppm, about 74 ppm, about 75 ppm, about 76 ppm, about 77 ppm, about 78 ppm, about 79 ppm, about 80 ppm, about 81 ppm, about 82 ppm, about 83 ppm, about 84 ppm, about 85 ppm, about 86 ppm, about 87 ppm, about 88 ppm, about 89 ppm, about 90 ppm, about 91 ppm, about 92 ppm, about 93 ppm, about 94 ppm, about 95 ppm, about 96 ppm, about 97 ppm, about 98 ppm, about 99 ppm about 100 ppm, about 110 ppm, about 120 ppm, about 130 ppm, about 140 ppm, about 150 ppm, about 160 ppm, about 170 ppm, about 180 ppm, about 190 ppm, about 200 ppm, about 210 ppm, about 220 ppm, about 230 ppm, about 240 ppm, about 250 ppm, about 260 ppm, about 270 ppm, about 280 ppm, about 290 ppm, about 300 ppm, about 310 ppm, about 320 ppm, about 330 ppm, about 340 ppm, about 350 ppm, about 360 ppm, about 370 ppm, about 380 ppm, about 390 ppm, about 400 ppm, about 410 ppm, about 420 ppm, about 430 ppm, about 440 ppm, about 450 ppm, about 460 ppm, about 470 ppm, about 480 ppm, about 490 ppm, about 500 ppm, about 510 ppm, about 520 ppm, about 530 ppm, about 540 ppm, about 550 ppm, about 560 ppm, about 570 ppm, about 580 ppm, about 590 ppm, about 600 ppm, about 610 ppm, about 620 ppm, about 630 ppm, about 640 ppm, about 650 ppm, about 660 ppm, about 670 ppm, about 680 ppm, about 690 ppm, about 700 ppm, about 710 ppm, about 720 ppm, about 730 ppm, about 740 ppm, about 750 ppm, about 760 ppm, about 770 ppm, about 780 ppm, about 790 ppm, about 800 ppm, about 810 ppm, about 820 ppm, about 830 ppm, about 840 ppm, about 850 ppm, about 860 ppm, about 870 ppm, about 880 ppm, about 890 ppm, about 900 ppm, about 910 ppm, about 920 ppm, about 930 ppm, about 940 ppm, about 950 ppm, about 960 ppm, about 970 ppm, about 980 ppm, about 990 ppm, about 1,000 ppm.

In a particular embodiment, the beverage comprises between about 1 and about 80 ppm of monk fruit extract, more particularly, between about 30 and about 60 ppm, about 40 and about 55 ppm, about 45 and 55 ppm, about 46 and about 54 ppm or about 48 and about 52 ppm of monk fruit extract.

In another particular embodiment, the beverages comprises about 40, about 42, about 44, about 46, about 48, about 50, about 52, about 54, about 56, about 58 or about 60 ppm of monk fruit extract.

The amount of sucralose may vary. In one embodiment, the sucralose is present in the beverage in about 10 ppm, about 11 ppm, about 12 ppm, about 13 ppm, about 14 ppm, about 15 ppm, about 16 ppm, about 17 ppm, about 18 ppm, about 19 ppm, about 20 ppm, about 21 ppm, about 22 ppm, about 23 ppm, about 24 ppm, about 25 ppm, about 26 ppm, about 27 ppm, about 28 ppm, about 29 ppm, about 30 ppm, about 31 ppm, about 32 ppm, about 33 ppm, about 34 ppm, about 35 ppm, about 36 ppm, about 37 ppm, about 38 ppm, about 39 ppm, about 40 ppm, about 41 ppm, about 42 ppm, about 43 ppm, about 44 ppm, about 45 ppm, about 46 ppm, about 47 ppm, about 48 ppm, about 49 ppm, about 50 ppm, about 51 ppm, about 52 ppm, about 53 ppm, about 54 ppm, about 55 ppm, about 56 ppm, about 57 ppm, about 58 ppm, about 59 ppm, about 60 ppm, about 61 ppm, about 62 ppm, about 63 ppm, about 64 ppm, about 65 ppm, about 66 ppm, about 67 ppm, about 68 ppm, about 69 ppm, about 70 ppm, about 71 ppm, about 72 ppm, about 73 ppm, about 74 ppm, about 75 ppm, about 76 ppm, about 77 ppm, about 78 ppm, about 79 ppm, about 80 ppm, about 81 ppm, about 82 ppm, about 83 ppm, about 84 ppm, about 85 ppm, about 86 ppm, about 87 ppm, about 88 ppm, about 89 ppm, about 90 ppm, about 91 ppm, about 92 ppm, about 93 ppm, about 94 ppm, about 95 ppm, about 96 ppm, about 97 ppm, about 98 ppm, about 99 ppm about 100 ppm, about 110 ppm, about 120 ppm, about 130 ppm, about 140 ppm, about 150 ppm, about 160 ppm, about 170 ppm, about 180 ppm, about 190 ppm, about 200 ppm, about 210 ppm, about 220 ppm, about 230 ppm, about 240 ppm, about 250 ppm, about 260 ppm, about 270 ppm, about 280 ppm, about 290 ppm, about 300 ppm, about 310 ppm, about 320 ppm, about 330 ppm, about 340 ppm, about 350 ppm, about 360 ppm, about 370 ppm, about 380 ppm, about 390 ppm, about 400 ppm, about 410 ppm, about 420 ppm, about 430 ppm, about 440 ppm, about 450 ppm, about 460 ppm, about 470 ppm, about 480 ppm, about 490 ppm, about 500 ppm, about 510 ppm, about 520 ppm, about 530 ppm, about 540 ppm, about 550 ppm, about 560 ppm, about 570 ppm, about 580 ppm, about 590 ppm, about 600 ppm, about 610 ppm, about 620 ppm, about 630 ppm, about 640 ppm, about 650 ppm, about 660 ppm, about 670 ppm, about 680 ppm, about 690 ppm, about 700 ppm, about 710 ppm, about 720 ppm, about 730 ppm, about 740 ppm, about 750 ppm, about 760 ppm, about 770 ppm, about 780 ppm, about 790 ppm, about 800 ppm, about 810 ppm, about 820 ppm, about 830 ppm, about 840 ppm, about 850 ppm, about 860 ppm, about 870 ppm, about 880 ppm, about 890 ppm, about 900 ppm, about 910 ppm, about 920 ppm, about 930 ppm, about 940 ppm, about 950 ppm, about 960 ppm, about 970 ppm, about 980 ppm, about 990 ppm, about 1,000 ppm.

In a particular embodiment, the beverage comprises between about 50 and about 150 ppm of sucralose, more particularly, between about 75 and about 125 μm, about 85 and 100 ppm, or about 90 and about 95 ppm of sucralose.

In a particular embodiment, the beverage comprises about 88, about 90, about 92, about 94, about 96, or about 98 ppm of sucralose.

In certain embodiments, a enhanced water beverage is provided that comprises between about 90 and 95 ppm sucralose and about 45 and about 52 ppm monk fruit extract, wherein the monk fruit extract comprises between about 35 and about 55 wt. % mogroside V. Optionally, the enhanced water beverage does include one or more of erythritol, a rebaudioside (e.g., rebaudioside A or rebaudioside B) or a rare sugar (e.g., allulose).

Optionally, the enhanced water beverage disclosed herein may also contain one or more dihydrochalcone, such as phloretin, shown below.

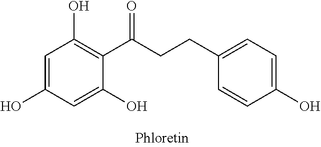 [SMILES: O=C(CCc1ccc(O)cc1)c1c(O)cc(O)cc1O]

The amount of phloretin may vary. In one embodiment, the phloretin is present in the beverage in about 10 ppm, about 11 ppm, about 12 ppm, about 13 ppm, about 14 ppm, about 15 ppm, about 16 ppm, about 17 ppm, about 18 ppm, about 19 ppm, about 20 ppm, about 21 ppm, about 22 ppm, about 23 ppm, about 24 ppm, about 25 ppm, about 26 ppm, about 27 ppm, about 28 ppm, about 29 ppm, about 30 ppm, about 31 ppm, about 32 ppm, about 33 ppm, about 34 ppm, about 35 ppm, about 36 ppm, about 37 ppm, about 38 ppm, about 39 ppm, about 40 ppm, about 41 ppm, about 42 ppm, about 43 ppm, about 44 ppm, about 45 ppm, about 46 ppm, about 47 ppm, about 48 ppm, about 49 ppm, about 50 ppm, about 51 ppm, about 52 ppm, about 53 ppm, about 54 ppm, about 55 ppm, about 56 ppm, about 57 ppm, about 58 ppm, about 59 ppm, about 60 ppm, about 61 ppm, about 62 ppm, about 63 ppm, about 64 ppm, about 65 ppm, about 66 ppm, about 67 ppm, about 68 ppm, about 69 ppm, about 70 ppm, about 71 ppm, about 72 ppm, about 73 ppm, about 74 ppm, about 75 ppm, about 76 ppm, about 77 ppm, about 78 ppm, about 79 ppm, about 80 ppm, about 81 ppm, about 82 ppm, about 83 ppm, about 84 ppm, about 85 ppm, about 86 ppm, about 87 ppm, about 88 ppm, about 89 ppm, about 90 ppm, about 91 ppm, about 92 ppm, about 93 ppm, about 94 ppm, about 95 ppm, about 96 ppm, about 97 ppm, about 98 ppm, about 99 ppm about 100 ppm, about 110 ppm, about 120 ppm, about 130 ppm, about 140 ppm, about 150 ppm, about 160 ppm, about 170 ppm, about 180 ppm, about 190 ppm, about 200 ppm, about 210 ppm, about 220 ppm, about 230 ppm, about 240 ppm, about 250 ppm, about 260 ppm, about 270 ppm, about 280 ppm, about 290 ppm, about 300 ppm, about 310 ppm, about 320 ppm, about 330 ppm, about 340 ppm, about 350 ppm, about 360 ppm, about 370 ppm, about 380 ppm, about 390 ppm, about 400 ppm, about 410 ppm, about 420 ppm, about 430 ppm, about 440 ppm, about 450 ppm, about 460 ppm, about 470 ppm, about 480 ppm, about 490 ppm, about 500 ppm, about 510 ppm, about 520 ppm, about 530 ppm, about 540 ppm, about 550 ppm, about 560 ppm, about 570 ppm, about 580 ppm, about 590 ppm, about 600 ppm, about 610 ppm, about 620 ppm, about 630 ppm, about 640 ppm, about 650 ppm, about 660 ppm, about 670 ppm, about 680 ppm, about 690 ppm, about 700 ppm, about 710 ppm, about 720 ppm, about 730 ppm, about 740 ppm, about 750 ppm, about 760 ppm, about 770 ppm, about 780 ppm, about 790 ppm, about 800 ppm, about 810 ppm, about 820 ppm, about 830 ppm, about 840 ppm, about 850 ppm, about 860 ppm, about 870 ppm, about 880 ppm, about 890 ppm, about 900 ppm, about 910 ppm, about 920 ppm, about 930 ppm, about 940 ppm, about 950 ppm, about 960 ppm, about 970 ppm, about 980 ppm, about 990 ppm, about 1,000 ppm.

In one embodiment, the amount of phloretin is between about 100 ppm and about 800 ppm, more particularly, between about 200 ppm and about 700 ppm or about 300 ppm and about 600 ppm. In one embodiment, the amount of phloretin is between about 450 and about 550 ppm.

In one embodiment, the amount of phloretin is about 400 ppm, about 450 ppm, about 500 ppm, about 550 ppm, or about 600 ppm.

In certain embodiments, an enhanced water beverage is provided that comprises between about 90 and 95 ppm sucralose, about 45 and about 52 ppm monk fruit extract and about 400 ppm to about 600 ppm (e.g., 500 ppm) of phloretin, wherein the monk fruit extract comprises between about 35 and about 55 wt. % mogroside V. Optionally, the enhanced water beverage does include one or more of erythritol, a rebaudioside (e.g., rebaudioside A or rebaudioside B) or a rare sugar (e.g., allulose).

Advantageously, the enhanced water beverage disclosed herein may contain one or more sensory characteristics or attributes that are improved relative to enhanced water beverages known in the art, for example, enhanced water beverages comprising sucrose and erythritol. The sensor characteristic or attribute may vary and includes, reduced sweetness linger, improved sweetness onset, improved mouth feel and reduced off-tastes.

The improvement in the one or more sensory characteristics or attributes may be tested or shown in any suitable manner. In one embodiment, the improvement is shown by comparative testing using trained sensory evaluators.

In one embodiment, the enhanced water beverage disclosed herein has reduced off-taste, and more particularly, off-taste is reduced by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% or more.

In one embodiment, the enhanced water beverage disclosed herein has reduced off-taste, and more particularly, off-taste is reduced by about 1.1-fold, about 1.2-fold, about 1.3-fold, about 1.4-fold, about 1.5-fold, about 1.6-fold, about 1.7-fold, about 1.8-fold, about 1.9-fold, about 2-fold, about 2.1-fold, about 2.2-fold, about 2.3-fold, about 2.4-fold, about 2.5-fold, about 2.6-fold, about 2.7-fold, about 2.8-fold, about 2.9-fold, about 3-fold, about 3.1-fold, about 3.2-fold, about 3.3-fold, about 3.4-fold, about 3.5-fold, about 3.6-fold, about 3.7-fold, about 3.8-fold, about 3.9-fold, about 4-fold, about 4.1-fold, about 4.2-fold, about 4.3-fold, about 4.4-fold, about 4.5-fold, about 4.6-fold, about 4.7-fold, about 4.8-fold, about 4.9-fold, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, about 20-fold, about 21-fold, about 22-fold, about 23-fold, about 24-fold, about 25-fold, about 26-fold, about 27-fold, about 28-fold, about 29-fold, about 30-fold, about 31-fold, about 32-fold, about 33-fold, about 34-fold, about 35-fold, about 36-fold, about 37-fold, about 38-fold, about 39-fold, about 40-fold, about 41-fold, about 42-fold, about 43-fold, about 44-fold, about 45-fold, about 46-fold, about 47-fold, about 48-fold, about 49-fold, about 50-fold, about 51-fold, about 52-fold, about 53-fold, about 54-fold, about 55-fold, about 56-fold, about 57-fold, about 58-fold, about 59-fold, about 60-fold, about 61-fold, about 62-fold, about 63-fold, about 64-fold, about 65-fold, about 66-fold, about 67-fold, about 68-fold, about 69-fold, about 70-fold, about 71-fold, about 72-fold, about 73-fold, about 74-fold, about 75-fold, about 76-fold, about 77-fold, about 78-fold, about 79-fold, about 80-fold, about 81-fold, about 82-fold, about 83-fold, about 84-fold, about 85-fold, about 86-fold, about 87-fold, about 88-fold, about 89-fold, about 90-fold, about 91-fold, about 92-fold, about 93-fold, about 94-fold, about 95-fold, about 96-fold, about 97-fold, about 98-fold, about 99-fold, or about 100-fold or more.

In one embodiment, the enhanced water beverage disclosed herein has reduced bitterness and more particularly, bitterness is reduced by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% or more.

In another embodiment, the bitterness of the enhanced water beverage disclosed herein is reduced about 1.1-fold, about 1.2-fold, about 1.3-fold, about 1.4-fold, about 1.5-fold, about 1.6-fold, about 1.7-fold, about 1.8-fold, about 1.9-fold, about 2-fold, about 2.1-fold, about 2.2-fold, about 2.3-fold, about 2.4-fold, about 2.5-fold, about 2.6-fold, about 2.7-fold, about 2.8-fold, about 2.9-fold, about 3-fold, about 3.1-fold, about 3.2-fold, about 3.3-fold, about 3.4-fold, about 3.5-fold, about 3.6-fold, about 3.7-fold, about 3.8-fold, about 3.9-fold, about 4-fold, about 4.1-fold, about 4.2-fold, about 4.3-fold, about 4.4-fold, about 4.5-fold, about 4.6-fold, about 4.7-fold, about 4.8-fold, about 4.9-fold, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, about 20-fold, about 21-fold, about 22-fold, about 23-fold, about 24-fold, about 25-fold, about 26-fold, about 27-fold, about 28-fold, about 29-fold, about 30-fold, about 31-fold, about 32-fold, about 33-fold, about 34-fold, about 35-fold, about 36-fold, about 37-fold, about 38-fold, about 39-fold, about 40-fold, about 41-fold, about 42-fold, about 43-fold, about 44-fold, about 45-fold, about 46-fold, about 47-fold, about 48-fold, about 49-fold, about 50-fold, about 51-fold, about 52-fold, about 53-fold, about 54-fold, about 55-fold, about 56-fold, about 57-fold, about 58-fold, about 59-fold, about 60-fold, about 61-fold, about 62-fold, about 63-fold, about 64-fold, about 65-fold, about 66-fold, about 67-fold, about 68-fold, about 69-fold, about 70-fold, about 71-fold, about 72-fold, about 73-fold, about 74-fold, about 75-fold, about 76-fold, about 77-fold, about 78-fold, about 79-fold, about 80-fold, about 81-fold, about 82-fold, about 83-fold, about 84-fold, about 85-fold, about 86-fold, about 87-fold, about 88-fold, about 89-fold, about 90-fold, about 91-fold, about 92-fold, about 93-fold, about 94-fold, about 95-fold, about 96-fold, about 97-fold, about 98-fold, about 99-fold, or about 100-fold or more.

In one embodiment, the enhanced water beverage disclosed herein has improved mouthfeel and more particularly, mouthfeel is improved about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% or more.

In another embodiment, the mouthfeel of the enhanced water beverage disclosed herein is improved by about 1.1-fold, about 1.2-fold, about 1.3-fold, about 1.4-fold, about 1.5-fold, about 1.6-fold, about 1.7-fold, about 1.8-fold, about 1.9-fold, about 2-fold, about 2.1-fold, about 2.2-fold, about 2.3-fold, about 2.4-fold, about 2.5-fold, about 2.6-fold, about 2.7-fold, about 2.8-fold, about 2.9-fold, about 3-fold, about 3.1-fold, about 3.2-fold, about 3.3-fold, about 3.4-fold, about 3.5-fold, about 3.6-fold, about 3.7-fold, about 3.8-fold, about 3.9-fold, about 4-fold, about 4.1-fold, about 4.2-fold, about 4.3-fold, about 4.4-fold, about 4.5-fold, about 4.6-fold, about 4.7-fold, about 4.8-fold, about 4.9-fold, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, about 20-fold, about 21-fold, about 22-fold, about 23-fold, about 24-fold, about 25-fold, about 26-fold, about 27-fold, about 28-fold, about 29-fold, about 30-fold, about 31-fold, about 32-fold, about 33-fold, about 34-fold, about 35-fold, about 36-fold, about 37-fold, about 38-fold, about 39-fold, about 40-fold, about 41-fold, about 42-fold, about 43-fold, about 44-fold, about 45-fold, about 46-fold, about 47-fold, about 48-fold, about 49-fold, about 50-fold, about 51-fold, about 52-fold, about 53-fold, about 54-fold, about 55-fold, about 56-fold, about 57-fold, about 58-fold, about 59-fold, about 60-fold, about 61-fold, about 62-fold, about 63-fold, about 64-fold, about 65-fold, about 66-fold, about 67-fold, about 68-fold, about 69-fold, about 70-fold, about 71-fold, about 72-fold, about 73-fold, about 74-fold, about 75-fold, about 76-fold, about 77-fold, about 78-fold, about 79-fold, about 80-fold, about 81-fold, about 82-fold, about 83-fold, about 84-fold, about 85-fold, about 86-fold, about 87-fold, about 88-fold, about 89-fold, about 90-fold, about 91-fold, about 92-fold, about 93-fold, about 94-fold, about 95-fold, about 96-fold, about 97-fold, about 98-fold, about 99-fold, or about 100-fold or more.

In one embodiment, the enhanced water beverage disclosed herein has improved sweetness onset and more particularly, sweetness onset is improved about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% or more.

In another embodiment, the sweetness onset of the enhanced water beverage disclosed herein is improved by about 1.1-fold, about 1.2-fold, about 1.3-fold, about 1.4-fold, about 1.5-fold, about 1.6-fold, about 1.7-fold, about 1.8-fold, about 1.9-fold, about 2-fold, about 2.1-fold, about 2.2-fold, about 2.3-fold, about 2.4-fold, about 2.5-fold, about 2.6-fold, about 2.7-fold, about 2.8-fold, about 2.9-fold, about 3-fold, about 3.1-fold, about 3.2-fold, about 3.3-fold, about 3.4-fold, about 3.5-fold, about 3.6-fold, about 3.7-fold, about 3.8-fold, about 3.9-fold, about 4-fold, about 4.1-fold, about 4.2-fold, about 4.3-fold, about 4.4-fold, about 4.5-fold, about 4.6-fold, about 4.7-fold, about 4.8-fold, about 4.9-fold, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, about 20-fold, about 21-fold, about 22-fold, about 23-fold, about 24-fold, about 25-fold, about 26-fold, about 27-fold, about 28-fold, about 29-fold, about 30-fold, about 31-fold, about 32-fold, about 33-fold, about 34-fold, about 35-fold, about 36-fold, about 37-fold, about 38-fold, about 39-fold, about 40-fold, about 41-fold, about 42-fold, about 43-fold, about 44-fold, about 45-fold, about 46-fold, about 47-fold, about 48-fold, about 49-fold, about 50-fold, about 51-fold, about 52-fold, about 53-fold, about 54-fold, about 55-fold, about 56-fold, about 57-fold, about 58-fold, about 59-fold, about 60-fold, about 61-fold, about 62-fold, about 63-fold, about 64-fold, about 65-fold, about 66-fold, about 67-fold, about 68-fold, about 69-fold, about 70-fold, about 71-fold, about 72-fold, about 73-fold, about 74-fold, about 75-fold, about 76-fold, about 77-fold, about 78-fold, about 79-fold, about 80-fold, about 81-fold, about 82-fold, about 83-fold, about 84-fold, about 85-fold, about 86-fold, about 87-fold, about 88-fold, about 89-fold, about 90-fold, about 91-fold, about 92-fold, about 93-fold, about 94-fold, about 95-fold, about 96-fold, about 97-fold, about 98-fold, about 99-fold, or about 100-fold or more.

In one embodiment, the enhanced water beverage disclosed herein has reduced sweetness linger and more particularly, sweetness linger is reduced by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% or more.

In another embodiment, the sweetness linger of the enhanced water beverage disclosed herein is reduced about 1.1-fold, about 1.2-fold, about 1.3-fold, about 1.4-fold, about 1.5-fold, about 1.6-fold, about 1.7-fold, about 1.8-fold, about 1.9-fold, about 2-fold, about 2.1-fold, about 2.2-fold, about 2.3-fold, about 2.4-fold, about 2.5-fold, about 2.6-fold, about 2.7-fold, about 2.8-fold, about 2.9-fold, about 3-fold, about 3.1-fold, about 3.2-fold, about 3.3-fold, about 3.4-fold, about 3.5-fold, about 3.6-fold, about 3.7-fold, about 3.8-fold, about 3.9-fold, about 4-fold, about 4.1-fold, about 4.2-fold, about 4.3-fold, about 4.4-fold, about 4.5-fold, about 4.6-fold, about 4.7-fold, about 4.8-fold, about 4.9-fold, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, about 20-fold, about 21-fold, about 22-fold, about 23-fold, about 24-fold, about 25-fold, about 26-fold, about 27-fold, about 28-fold, about 29-fold, about 30-fold, about 31-fold, about 32-fold, about 33-fold, about 34-fold, about 35-fold, about 36-fold, about 37-fold, about 38-fold, about 39-fold, about 40-fold, about 41-fold, about 42-fold, about 43-fold, about 44-fold, about 45-fold, about 46-fold, about 47-fold, about 48-fold, about 49-fold, about 50-fold, about 51-fold, about 52-fold, about 53-fold, about 54-fold, about 55-fold, about 56-fold, about 57-fold, about 58-fold, about 59-fold, about 60-fold, about 61-fold, about 62-fold, about 63-fold, about 64-fold, about 65-fold, about 66-fold, about 67-fold, about 68-fold, about 69-fold, about 70-fold, about 71-fold, about 72-fold, about 73-fold, about 74-fold, about 75-fold, about 76-fold, about 77-fold, about 78-fold, about 79-fold, about 80-fold, about 81-fold, about 82-fold, about 83-fold, about 84-fold, about 85-fold, about 86-fold, about 87-fold, about 88-fold, about 89-fold, about 90-fold, about 91-fold, about 92-fold, about 93-fold, about 94-fold, about 95-fold, about 96-fold, about 97-fold, about 98-fold, about 99-fold, or about 100-fold or more.

In certain embodiments, the sucralose and the monk fruit extract act in a synergistic manner.

The sucrose equivalence (SE) of the enhanced water beverage may vary. In one embodiment, the sucrose equivalence 1% (w/v), about 2%, about 3%, about 4%, about 5%, about 6%, about 7%, about 8%, about 9%, about 10%, about 11%, about 12%, about 13%, about 14% or any range between these values. In a particular embodiment, the enhanced water beverage has a sucrose equivalence of between about 5% and about 6%.

The enhanced water beverage disclosed herein may contain one or more additional ingredients.

In one embodiment, the enhanced water beverage contains at least one vitamin and/or electrolyte.

In certain embodiments, the vitamin is selected from the group consisting of vitamin A, vitamin D, vitamin E, vitamin K, vitamin B1, vitamin B2, vitamin B3, vitamin B5, vitamin B6, vitamin B7, vitamin B9, vitamin B12, vitamin C, and combinations thereof.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

In particular embodiments, the vitamin is selected from the group consisting of vitamin A, vitamin C, vitamin E, vitamin B3, vitamin B5, vitamin B6, vitamin B12, and combinations thereof.

In one embodiment, the beverage disclosed herein contains one or more electrodes. The electrolyte may be sodium, potassium, calcium, magnesium, chloride, phosphate, bicarbonate, citrate, lactate, gluconate, and combinations thereof. The electrolytes are usually, but not necessarily, obtainable from their corresponding water-soluble and non-toxic salts. Unless otherwise defined, the amount of electrolytes or ionic components in the beverage is based on those present in the final drinkable beverage composition. The electrolyte concentration is of the ion only and not the salt.

The beverages disclosed herein preferably contain a total electrolyte concentration of at least about 50 mg/mL, at least about 100 mg/mL, at least about 200 mg/L, at least about 300 mg/L, at least about 400 mg/L, at least about 500 mg/L, at least about 600 mg/L, at least about 700 mg/L or at least about 800 mg/L. In a particular embodiment, the beverages contain an electrolyte concentration from about 400 mg/L to about 1,000 mg/L, from about 400 mg/L to about 900 mg/L, from about 400 mg/L to about 800 mg/L, from about 400 mg/L to about 700 mg/L, from about 400 mg/L to about 600 mg/L, from about 400 mg/L to about 500 mg/L, from about 500 mg/L to about 1,000 mg/L.

The potassium ion component can be provided by any salt including the chloride, carbonate, sulfate, acetate, bicarbonate, citrate, phosphate, hydrogen phosphate, tartrate, sorbate or a combination thereof. The potassium ions are preferably present in the beverage of the present invention in an amount of at least 0.0025% to about 0.08% by weight, from about 0.0075% to about 0.06% or from about 0.0075% to about 0.015%.

The beverage disclosed herein can contain from about 5 mg/L to about 1,000 mg/L potassium, more preferably from about 50 mg/L to about 300 mg/L, such as, for example, from about 100 mg/L to about 300 mg/L, from about 200 mg/L to about 300 mg/L, from about 50 mg/L to about 200 mg/L, from about 100 mg/L to about 200 mg/L or from about 100 mg/L to about 200 mg/L.

The sodium ion component can be provided by any salt such as the chloride, carbonate, sulfate, acetate, bicarbonate, citrate, phosphate, hydrogen phosphate, tartrate, sorbate or a combination thereof. The sodium ions are preferably present in the beverage of the present invention in an amount of at least about 0.005% to about 0.1% by weight, from about 0.0075% to about 0.075% or about 0.015% to about 0.05%.

The beverage disclosed herein can contain from about 5 mg/L to about 1,000 mg/L sodium, more preferably from about 300 mg/L to about 800 mg/L sodium, such as, for example, from about 300 mg/L to about 700 mg/L, from about 300 mg/L to about 600 mg/L, from about 300 mg/L to about 500 mg/L, from about 300 mg/L to about 400 mg/L, from about 400 mg/L to about 800 mg/L, from about 400 mg/L to about 700 mg/L, from about 400 mg/L to about 600 mg/L from about 400 mg/L to about 500 mg/L, from about 500 mg/L to about 800 mg/L, from about 500 mg/L to about 700 mg/L, from about 500 mg/L to about 600 mg/L, from about 600 mg/L to about 800 mg/L, from about 600 mg/L to about 700 mg/L and from about 700 mg/L to about 800 mg/L. In a particular embodiment, the beverages of the present invention contain from about 600 mg/L to about 700 mg/L sodium.

The beverage disclosed herein may contain a calcium ion component. The calcium ion component can be provided by any salt such as the lactate, chloride, carbonate, sulfate, acetate, bicarbonate, citrate, phosphate, hydrogen phosphate, tartrate, sorbate or a combination thereof. The calcium ions are preferably present in the beverage of the present invention in an amount of at least about 0.0005% to about 0.010% by weight.

The beverage disclosed herein can contain from about 5 mg/L to about 1,000 mg/L calcium, more preferably from about 1 mg/L to about 50 mg/L, such as, for example, from about 5 mg/L to about 10 mg/L.

The beverage disclosed herein may contain a magnesium ion component. The magnesium ion component can be provided by any salt such as the lactate, chloride, carbonate, sulfate, acetate, bicarbonate, citrate, phosphate, hydrogen phosphate, tartrate, sorbate or a combination thereof. The magnesium ions are preferably present in the beverage of the present invention in an amount of at least about 0.0005% to about 0.010% by weight.

The beverage of the present invention can contain from about 5 mg/L to about 1,000 mg/L magnesium, more preferably from about 1 mg/L to about 50 mg/L, such as, for example, from about 5 mg/L to about 20 mg/L.

The beverage disclosed herein may contain a chloride ion component. The beverage can contain chloride ion from about 0.005% to about 0.20% by weight, from about 0.01% to about 0.15% or from about 0.02% to about 0.075%. The chloride ion component can be provided by a salt such as sodium chloride, potassium chloride or a combination thereof.

In a particular embodiment, a beverage disclosed herein may contain at least one electrolyte selected from the group consisting of magnesium, calcium, potassium, phosphate, or combinations thereof. Magnesium and calcium are preferably supplied in the lactate forms. Potassium is preferably supplied in the form of potassium phosphate. Phosphate is preferably supplied in the form of calcium or potassium phosphate.

The enhanced water beverages disclosed herein also contain at least one natural flavor, e.g., fruit or herb flavors. The flavor can be provided in any suitable form.

Exemplary fruit flavors include, but are not limited to, açai, apple, apricot, avocado, banana, blackberry, black currant, blueberry, breadfruit, cantaloupe, carambola, cherimoya, cherry, clementine, coconut, cranberry, custard-apple, date, dragonfruit, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarind, tangerine, watermelon and combinations thereof.

Exemplary herb flavors include, but are not limited to chamomile, peppermint, hibiscus, lavender, marigold, chrysanthemum, ginger, turmeric, and combinations thereof.

The enhanced water beverage disclosed herein may optionally contain at least one rare sugar sweetener.

Exemplary rare sugar sweeteners include, but are not limited to, allulose (D-psicose), L-ribose, D-tagatose, L-glucose, L-fucose, L-arabinose, D-turanose, D-leubiose (D-leucose), and combinations thereof.

The amount of rare sugar sweetener in the beverage depends on the identity of the rare sugar and the permitted regulatory limit. In one embodiment, a beverage comprises a rare sugar in an amount from about 0.1 wt % to 12 wt %, from about 0.1 wt % to about 5 wt %, from about 0.1 wt % to about 2.5 wt %, about 0.1 wt % to about 2 wt %, or about 0.1 wt % to about 1 wt %.

The enhanced water beverage disclosed herein may optionally contain at least one sugar alcohol sweetener. Exemplary sugar alcohols include, but are not limited to, sorbitol, mannitol, lactitol, maltitol, xylitol, erythritol and combinations thereof. In a particular embodiment, the sugar alcohol is erythritol.

The at least one sugar alcohol can be present the beverages in an amount from about 0.1 wt % to about 8 wt %, such as, for example, from about 1 wt % to about 8 wt %, from about 1 wt % to about 5 wt %, from about 1 wt % to about 3 wt %, from about 3 wt % to about 8 wt %, from about 3 wt % to about 5 wt % or from about 5 wt % to about 8 wt %.

The enhanced water beverages described herein optionally include at least one functional ingredient. Exemplary functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponaria), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, «-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, resveratrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is resveratrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, MD), OmegaPure (from Omega Protein, Houston, TX), Marinol C-38 (from Lipid Nutrition, Channahon, IL), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the beverage disclosed herein include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is glucosamine, optionally further comprising chondroitin sulfate.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside III, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T. officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen-like effect of any degree. For example, a phytoestrogen may bind to estrogen receptors within the body and have a small estrogen-like effect.

Examples of suitable phytoestrogens for embodiments of the beverage disclosed herein include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (—OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom 1-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., β-sitosterol, campesterol, stigmasterol, brassicasterol, 22-dehydrobrassicasterol, and A5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the □ and □ isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

The enhanced water beverages described herein can further include at least one additive. Exemplary additives include, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and

The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

In a particular embodiment, the beverage disclosed herein does not contain erythritol.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid, glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine.

Suitable polyamino acid additives include poly-L-aspartic acid, poly-L-lysine, poly-L-ornithine, poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C₂-C₃₀ carboxylic acids, substituted hydroxyl C₂-C₃₀ carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), gluconic acid (e.g., gluconate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in a consumable, such as, for example, a beverage.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, New Jersey, U.S.A.), and Sucramask™ (Creative Research Management, Stockton, California, U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like. Suitable alcohol additives include, but are not limited to, ethanol.

Suitable astringent compound additives include, but are not limited to, tannic acid, europium chloride (EuCl3), gadolinium chloride (GdCl3), terbium chloride (TbCl3), alum, tannic acid, and polyphenols (e.g., tea polyphenols).

### III. Methods

Also provided herein are methods of improving one or more characteristics of a beverage (e.g., an enhanced water beverage, as well as method of making a beverage (e.g., an enhanced water beverage).

In one embodiment, a method is provided for improving one or more sensory characteristics or attributes of an enhanced water beverage is disclosed comprising (i) providing a monk fruit extract (MFE) and sucralose; (ii) adding the MFE and sucrose to a beverage matrix. In certain embodiments, the beverage (e.g., the enhanced water beverage) does not comprise erythritol. In other embodiments, the beverage (e.g., the enhanced water beverage) does not comprise a rebaudioside (e.g., rebaudioside A or B) or a rare sugar (e.g., allulose).

The sensory characteristics or attribute many vary. In one embodiment, the sensory characteristic or attribute is taste or off-taste, e.g., bitterness, astringency, sweetness linger.

In one embodiment, the method results in an improvement in taste or off-taste (e.g., bitterness, astringency, sweetness linger) of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% or more.

In one embodiment, the method results in an improvement in taste or off-taste (e.g., bitterness, astringency, sweetness linger) of about 1.1-fold, about 1.2-fold, about 1.3-fold, about 1.4-fold, about 1.5-fold, about 1.6-fold, about 1.7-fold, about 1.8-fold, about 1.9-fold, about 2-fold, about 2.1-fold, about 2.2-fold, about 2.3-fold, about 2.4-fold, about 2.5-fold, about 2.6-fold, about 2.7-fold, about 2.8-fold, about 2.9-fold, about 3-fold, about 3.1-fold, about 3.2-fold, about 3.3-fold, about 3.4-fold, about 3.5-fold, about 3.6-fold, about 3.7-fold, about 3.8-fold, about 3.9-fold, about 4-fold, about 4.1-fold, about 4.2-fold, about 4.3-fold, about 4.4-fold, about 4.5-fold, about 4.6-fold, about 4.7-fold, about 4.8-fold, about 4.9-fold, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, about 20-fold, about 21-fold, about 22-fold, about 23-fold, about 24-fold, about 25-fold, about 26-fold, about 27-fold, about 28-fold, about 29-fold, about 30-fold, about 31-fold, about 32-fold, about 33-fold, about 34-fold, about 35-fold, about 36-fold, about 37-fold, about 38-fold, about 39-fold, about 40-fold, about 41-fold, about 42-fold, about 43-fold, about 44-fold, about 45-fold, about 46-fold, about 47-fold, about 48-fold, about 49-fold, about 50-fold, about 51-fold, about 52-fold, about 53-fold, about 54-fold, about 55-fold, about 56-fold, about 57-fold, about 58-fold, about 59-fold, about 60-fold, about 61-fold, about 62-fold, about 63-fold, about 64-fold, about 65-fold, about 66-fold, about 67-fold, about 68-fold, about 69-fold, about 70-fold, about 71-fold, about 72-fold, about 73-fold, about 74-fold, about 75-fold, about 76-fold, about 77-fold, about 78-fold, about 79-fold, about 80-fold, about 81-fold, about 82-fold, about 83-fold, about 84-fold, about 85-fold, about 86-fold, about 87-fold, about 88-fold, about 89-fold, about 90-fold, about 91-fold, about 92-fold, about 93-fold, about 94-fold, about 95-fold, about 96-fold, about 97-fold, about 98-fold, about 99-fold, or about 100-fold or more.

In one embodiment, a method is provided for making a beverage (e.g., an enhanced water beverage), comprising (i) providing a monk fruit extract (MFE) and sucralose; (ii) adding the MFE and sucrose to a beverage matrix. In certain embodiments, the beverage (e.g., enhanced water beverage) does not comprise erythritol.

The following Examples are intended to be non-limiting.

### EXAMPLES

### Example 1: Preparation of Beverages

Beverages were prepared with the ingredients shown in Tables 1 and 2.

TABLE 1
Sparkling Beverage

| Carbonation | About 2.0 Vol. |
|---|---|
| Ingredients % | |
| Water | 99.7 |
| Acid | 0.100 |
| Sucralose | 0.011 |
| MFE (MV50) | 0.006 |
| Flavor | 0.110 |

TABLE 2
Still Beverage

| Carbonation | 0 Vol. |
|---|---|
| Ingredients % | |
| Water | 99.87 |
| Acid | 0.0115 |
| Sucralose | 0.007 |
| MFE (MV50) | 0.004 |
| Flavor | 0.001 |

### Example 2: Sensory Evaluation

Exemplary beverages were evaluated blindly by expert panelists. Samples were coded and randomly presented to the panelists. Panelists were instructed to eat an unsalted cracker and rinse the mouth with water before and in between samples. For each sample, panelists were instructed to take 3 sips, then write down their evaluation comments. The results are shown in Table with summaries of the common comments. Additional comments for each prototype are provide below. Ranges of sucralose and monk fruit extract shown in ppm.

TABLE 3
Sensory Results

| | Sucralose | Monk Fruit | Tastings and | |
|---|---|---|---|---|
| Product | range | Extract Range | number of | |
| Type | (ppm) | (ppm) | panelists | Common Comments |
| Carbonated | 95-106 | 50-56 | Prototype 9 Tasting | Positive: Less astringent. |
| | | | #1/7 tasters. Tasting | Mixed positive comments |
| | | | #2/5 tasters | on sweetness and flavor. |
| | | | | Negative: Linger. Mixed |
| | | | | negative comments on |
| | | | | sweetness and flavor. |
| | | | Prototype 10 | Positive: More |
| | | | Tastings #1, #2, #4, | mouthfeel. Mixed |
| | | | #5/7 tasters. Tasting | positive comments on |
| | | | #3/6 tasters | sweetness and flavor. |
| | | | | Negative: Linger, bitter, |
| | | | | astringent, sour. Mixed |
| | | | | negative comments on |
| | | | | sweetness and flavor. |
| Still | 50-80 | 20-60 | Prototype 4: 5-7 | Positive: Good |
| | | | Internal Tasters | mouthfeel. |
| | | | | Negative No common |
| | | | | negative comments. |
| | | | Prototype 5: 5-7 | Positive: Very close to |
| | | | Internal Tasters | control, good sweetness. |
| | | | | Negative: No common |
| | | | | negative comments. |

Comments from Prototype 9:
#1—Similar sweetness to Control, flavor is more lactonic/heavy, less of the upfront fresh peach notes. Good sweetness and flavor, less sparkling/astringent, sweetness is clean, worse than control, least peach note, sweeter and more sweet linger than control, good peach oolong flavor, good sweetness quality and level.
#2—Big peach flavor onset, sweet, little to no lingers, low sweet onset, linger but less astringent than others, less peach, bitter.
   Comments from Prototype 10:
#1—Flavor is very unbalanced compared to control, less mouthfeel. Sig. less sweet slow onset, sweet linger, worse than control, less peach, not even peach flavor, bitter after, more peach, less oolong flavor, bitter notes at end.
#2—fruity, juicy, peach flavor, some syrupy notes, more mouthfeel and peach flavor. slightly sweeter, more astringent than one, but also sight sweeter, more flavor notes, slight sour note on back end more flavor balanced.
#3—Slightly more sour different peach profile, milder than control V. SI. more sour, v. sl. less flavor intensity, slight less sweet but smoother or thinner, more sour ending sour upfront, good sweetness onset, slightly bitter, some cooling.
#4—Taste very close to sample #7 and sample #8. good flavor impact, similar sweetness, slight bitter note, much stronger peach flavor, not very astringent, sight bitter upfront, less flavor impact but not bad balanced but less flavor impact, less sweet, bitter, less flavor more peach but in the linger, better sweetness than sample #8.
#5—SI. more creamy, SI. more mouthfeel, similar sweetness, similar fruity character more fruity than control, creamy finish more fruity than control, slightly astringent cleaner in sweetness than control, more mouthfeel more floral peach, more upfront sweetness.
   Comments from Prototype 4:
Similar flavor intensity and profile to control, good mouthfeel (slightly more than control) very nice in flavor, bright and natural, juicy lemon, nice sweet and sour balance. All samples taste very good. I like the sugar notes in the end of this sample, juicy notes, good mouthfeel, lemonade like, very close to control, balanced flavor.
   Comments from Prototype 5:
Sweet, slight artificial flavor, juicy, coconut flavor on backend, slight juicier peach flavor, slight less creamy/dairy notes, good sweetness Slg. sweeter than control. Very close to control, cleaner than prototype 4. Tie with control. Very close to control, sl. less mouth feelgood sweetness, good mouthfeel, less lingering similar to control in tasting but slightly sweeter

1. An enhanced water beverage comprising sucralose and a monk fruit extract (MFE), wherein the beverage does not contain erythritol.

2. The enhanced water beverage of claim 1, wherein the enhanced water beverage does not comprise rebaudioside A or rebaudioside B.

3. The enhanced water beverage of claim 1, wherein the enhanced water beverage does not comprise allulose.

4. The enhanced water beverage of claim 1, wherein the enhanced water beverage comprises between about 85 and 100 ppm sucralose.

5. The enhanced water beverage of claim 1, wherein the enhanced water beverage comprises between about 45 and about 55 ppm monk fruit extract.

6. The enhanced water beverage of claim 1, further comprising phloretin.

7. The enhanced water beverage of claim 1, wherein the beverage has a sucrose equivalency of between about 7 and 8%.

8. The enhanced water beverage of claim 1, wherein the monk fruit extract comprises between about 35 and about 55% mogroside V.

9. The enhanced water beverage of claim 1, wherein the monk fruit extract comprises about 50% mogroside V.

10. A method of improving one or more sensory characteristics or attributes of an enhanced water beverage, comprising (i) providing a monk fruit extract and sucralose; (ii) adding the MFE and sucrose to a beverage matrix, wherein the beverage does not comprise erythritol.

11. The method of claim 10, wherein the beverage does not comprise rebaudioside A or rebaudioside B.

12. The method of claim 10, wherein the beverage does not comprise allulose.

13. The method of claim 10, wherein the beverage comprises between about 85 and 100 ppm sucralose.

14. The method of claim 10, wherein the beverage comprises between about 45 and about 55 ppm monk fruit extract.

15. The method of claim 10, wherein the beverage further comprises phloretin.

16. The method of claim 10, wherein the beverage has a sucrose equivalency of between about 7 and about 8%.

17. A method of making an enhanced water beverage, comprising (i) providing a monk fruit extract and sucralose; (ii) adding the MFE and sucrose to a beverage matrix, wherein the enhanced water beverage does not comprise erythritol.
